(19) United States
(12) Patent Application Publication
(10) Pub. No.: US 2023/0312964 A1
(43) Pub. Date: Oct. 5, 2023

(54) INKJET INKS SUITABLE FOR PRINTING ON NON-POROUS SUBSTRATES

(71) Applicant: KAO CORPORATION, Tokyo (JP)

(72) Inventors: Yuta MATSUMOTO, Cincinnati, OH (US); Todd TRITCAK, Cincinnati, OH (US)

(73) Assignee: KAO CORPORATION, Tokyo (JP)

(21) Appl. No.: 18/043,832

(22) PCT Filed: Oct. 21, 2020
(86) PCT No.: PCT/US2020/056599

§ 371 Date: Mar. 2, 2023

(51) Int. Cl. C09D 11/36; C09D 11/32; B41M 5/00

(52) U.S. Cl. CPC C09D 11/36; C09D 11/32; B41M 5/0047

(57) ABSTRACT

An inkjet ink that includes (A) a terpene resin, (B) a solvent system that includes (B1) methyl ethyl ketone, and (C) a polyether modified silicone having a hydrophilic-lipophilic balance (HLB) value of 1 to 12, which is characterized by extended decap times, quick drying properties, and providing high image sharpness. A printed article including the inkjet ink in dried form, and a method of forming a printed image with a thermal inkjet printhead are also provided.

### BACKGROUND OF THE INVENTION

### Field of the Invention

The present invention relates to inkjet inks, specifically inkjet inks that include (A) a terpene resin, (B) a solvent system that includes (B1) methyl ethyl ketone, and (C) a polyether modified silicone having a hydrophilic-lipophilic balance (HLB) value of 1 to 12.

### Discussion of the Background

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Thermal inkjet (TIJ) printing is a desirable technology for printing, coding, and marking as it offers high print resolutions at lower costs than competing technologies in the field, such as continuous inkjet methods. In thermal inkjet printing processes, the print cartridges contain a series of tiny chambers, each containing a heater, which produce ink droplets from thermal vaporization of an ink solvent. In the jetting process, a resistor is heated rapidly to produce a vapor bubble (hence the phrase “bubble jet”), which subsequently ejects a droplet from the orifice. This process is extremely efficient and reproducible and modern TIJ printheads for industrial graphics applications are capable of generating uniform droplets of 4 pL or smaller in volume at frequencies of 36 kHz or greater.

However, thermal inkjet printing can be troubled by poor reliability over time. For example, some inkjet inks suffer from short decap times, in which solvent losses due to prolonged exposure to air within an uncapped printhead leads to clogging/plugging of printhead nozzles, and thus unreliable ink jetting and image quality erosion over time. On the other hand, the use of special solvent systems with high boiling components to prevent such premature solvent losses in an uncapped printhead setting require extended drying times once the inks are applied and thus inefficient overall printing processes. Therefore, it is often difficult to counterbalance the need for long decap times (the need for a slow rate of solvent loss) and short drying times (the need for a fast rate of solvent loss).

Additionally, as printing systems are being increasingly incorporated into a wider variety of production environments, there is an increasing demand for greater versatility from thermal inkjet inks. For example, while thermal inkjet printers typically print very well onto porous/absorbent substrates, adhesion to more ‘difficult’ non-porous substrates, such as those common to labels, plastic bottles, metal cans, food packaging, and blister packaging (e.g., varnish coated paper, biaxially oriented polypropylene (BOPP), polyethylene terephthalate (PET), nylon, and aluminum) has been problematic. In attempts to improve adhesion, several inkjet ink systems have been reported that utilize binder resins. For example, US 2018/0251650 incorporated herein by reference in its entirety, reports the use of binder resins such as cellulose ester resins, sulfonamide-modified epoxy resins, rosin ester resins, terpene phenolic resins, polyurethanes, and acrylic resins for improved adhesion, and US 2017/0037269 and US 2015/0291816 each incorporated herein by reference in its entirety, report the use of terpene phenolic resins.

Even if adhesion to ‘difficult’ substrates can be addressed, such non-porous substrates pose a challenge for thermal inkjet applications because the volatile solvent in thermal inkjet inks affords the inks with low surface energy, and thus applied inkjet ink droplets tend to merge or bleed into one another on non-porous surfaces, which degrades image sharpness. In particular, coding and marking applications involve the printing of essential information, such as personal information, manufacturing lot, and expirations dates, and as such, poor image sharpness is unacceptable for these applications.

### SUMMARY OF THE INVENTION

In view of the forgoing, there is a need for inkjet inks that have extended decap times, dry quickly once applied, and provide images with desirable sharpness.

Accordingly, it is one object of the present invention to provide novel inkjet inks that meet these criteria.

It is another object of the present disclosure to provide novel printed articles which contain a dried form of the inkjet inks.

It is another object of the present disclosure to provide novel methods of forming a printed image on a substrate by applying the inkjet inks onto the substrate and drying.

These and other objects, which will become apparent during the following detailed description, have been achieved by the inventors' discovery that the combination of a terpene resin, methyl ethyl ketone (MEK), and a polyether modified silicone having an HLB value of 1 to 12 unexpectedly provides inkjet inks characterized by extended decap times, short drying times, and high image sharpness even when printed on ‘difficult’ non-porous substrates.

Thus, the present invention provides:
(1) An inkjet ink, comprising:
(A) a terpene resin;
(B) a solvent system comprising (B1) methyl ethyl ketone; and
(C) a polyether modified silicone having a hydrophilic-lipophilic balance (HLB) value of 1 to 12.
(2) The inkjet ink of (1), wherein the terpene resin (A) is a homopolymer made from α-pinene.
(3) The inkjet ink of (1) or (2), wherein the terpene resin (A) is present in an amount of 0.1 to 10 wt. %, based on a total weight of the inkjet ink.
(4) The inkjet ink of any one of (1) to (3), wherein a weight ratio of the methyl ethyl ketone (B1) to the terpene resin (A) ((B1):(A)) is 10:1 to 100:1.
(5) The inkjet ink of any one of (1) to (4), wherein the solvent system (B) further comprises (B2) acetone.
(6) The inkjet ink of (5), wherein a weight ratio of the methyl ethyl ketone (B1) to acetone (B2) ((B1):(B2)) is 1:1 to 5:1.
(7) The inkjet ink of any one of (1) to (6), which has a total ketone content of at least 50 wt. %, based on a total weight of the inkjet ink.
(8) The inkjet ink of any one of (1) to (7), wherein the solvent system (B) further comprises (B3) a glycol ether.
(9) The inkjet ink of any one of (1) to (8), which is substantially free of solvents having a boiling point higher than 175° C.
(10) The inkjet ink of any one of (1) to (9), wherein the polyether modified silicone (C) is a block copolymer having a pendent graft structure.
(11) The inkjet ink of any one of (1) to (10), wherein the polyether modified silicone (C) has an HLB value of 3 to 10.
(12) The inkjet ink of any one of (1) to (11), wherein the polyether modified silicone (C) is present in an amount of 0.001 to 4 wt. %, based on a total weight of the inkjet ink.
(13) The inkjet ink of any one of (1) to (12), further comprising (D) a rosin resin.
(14) The inkjet ink of (13), wherein the rosin resin (D) is a hydrogenated acidic rosin.
(15) The inkjet ink of (13) or (14), wherein the rosin resin (D) is present in an amount of up to 10 wt. %, based on a total weight of the inkjet ink.
(16) The inkjet ink of any one of (1) to (15), further comprising (E) a colorant.
(17) A printed article, comprising:
a substrate and a dried form of the inkjet ink of any one of (1) to (16) disposed on the substrate.
(18) A method of forming a printed image on a substrate, comprising:
applying the inkjet ink of any one of (1) to (16) onto the substrate with a thermal inkjet printhead; and
drying the inkjet ink.
(19) The method of (18), wherein the inkjet ink is dried by leaving exposed to air for 30 seconds or less.
(20) The method of (18) or (19), wherein a heater is not employed for drying the inkjet ink.

### BRIEF DESCRIPTION OF THE DRAWINGS

The foregoing paragraphs have been provided by way of general introduction, and are not intended to limit the scope of the following claims. The described embodiments, together with further advantages, will be best understood by reference to the following detailed description when considered in conjunction with the accompanying drawings, wherein:

FIG. 1 is a decap and dry time testing comparison between (top row) a common ink which includes low boiling point components that is fast drying but suffers from poor decap behavior, (middle row) a common ink which includes high boiling point components that has good decap behavior but is slow drying, and (bottom row) an inventive ink with a combination of good decap behavior and fast drying properties;

FIG. 2 illustrates the decap time evaluation criteria for a “Good” rating (no lines missing/unclear in a narrow line image), “Acceptable” rating (1 or 2 lines missing/unclear in a narrow line image), and a “Not Good” rating (more than 2 lines missing/unclear in a narrow line image);

FIG. 3 illustrates the image sharpness evaluation criteria for a “G” evaluation (sharp image, good separation), an “A” evaluation (a little spread but the lines can be recognized and moderate separation), and a “NG” evaluation (too much spread, lines cannot be recognized, poor separation) for both a narrow line image and a numeric sequence printed on aluminum foil.

FIG. 4 illustrates the image sharpness evaluation criteria for a numeric sequence image printed onto normal (non-coated) paper, varnish coated paper, biaxially oriented polypropylene, nylon, and aluminum foil, and a comparison between a common ink which received an image sharpness rating of “Not Good”, an Ink-A which received an image sharpness rating of “Acceptable”, and an Ink-B which received an image sharpness rating of “Good”.

### DETAILED DESCRIPTION OF THE INVENTION

In the following description, it is understood that other embodiments may be utilized and structural and operational changes may be made without departure from the scope of the present embodiments disclosed herein.

The phrase “substantially free”, unless otherwise specified, describes an amount of a particular component in the inkjet ink being less than 1 wt. %, preferably less than 0.5 wt. %, more preferably less than 0.1 wt. %, even more preferably less than 0.05 wt. %, yet even more preferably 0 wt. %, relative to a total weight of the inkjet ink.

As used herein, the terms “optional” or “optionally” means that the subsequently described event(s) can or cannot occur or the subsequently described component(s) may or may not be present (e.g., 0 wt. %).

The term “alkyl”, as used herein, unless otherwise specified, refers to a straight, branched, or cyclic, aliphatic fragment having at least 1, preferably at least 2, preferably at least 3, preferably at least 4 carbon atoms and up to 22, preferably up to 20, preferably up to 18, preferably up to 12, preferably up to 8 carbon atoms. Examples of alkyl groups include, but are not limited to, methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, lauryl, myristyl, cetyl, stearyl, and the like, including guerbet-type alkyl groups (e.g., 2-methylpentyl, 2-ethylhexyl, 2-proylheptyl, 2-butyloctyl, 2-pentylnonyl, 2-hexyldecyl, 2-heptylundecyl, 2-octyldodecyl, 2-nonyltridecyl, 2-decyltetradecyl, and 2-undecylpentadecyl). Cycloalkyl is a type of cyclized alkyl group. Exemplary cycloalkyl groups include, but are not limited to, cyclopropyl, cyclobutyl, cyclopentyl, cyclohexyl, norbornyl, and adamantyl.

As used herein, the term “fatty” describes a compound with a long-chain (linear) hydrophobic portion made up of hydrogen and anywhere from 8 to 22 carbon atoms, which may be fully saturated or partially unsaturated.

As used herein, the term “aryl” refers to an aromatic group containing only carbon in the aromatic ring(s), such as phenyl, biphenyl, naphthyl, anthracenyl, and the like.

The term “arylalkyl”, as used herein, refers to a straight, branched, or cyclic alkyl moiety (as defined above) that is substituted by an aryl group (as defined above) which may itself be optionally substituted by an alkyl group, examples of which include, but are not limited to, benzyl, phenethyl, 3-phenylpropyl, 2-phenylpropyl, 1-phenylpropyl, 4-phenylbutyl, 3-phenylbutyl, 2-phenylbutyl, 2-methylbenzyl, 3-methylbenzyl, 4-methylbenzyl, 2,4-dimethylbenzyl, 2-(4-ethylphenyl)ethyl, 3-(3-propylphenyl)propyl, and the like.

The term “(meth)acrylate” is used herein to refer to both acrylate and methacrylate groups. In other words, this term should be read as through “meth” is optional. Further, the term “(meth)acrylate” is used generally to refer to both acrylic acid-based compounds and acrylic ester-based compounds.

The term “decap behavior” herein, means the ability of the inkjet ink to readily eject from the printhead, upon prolonged exposure to air. The inkjet ink “decap time” is measured as the amount of time that an inkjet printhead may be left uncapped before the printer nozzles no longer fire properly, potentially because of clogging or plugging when printing resumes. Generally, nozzle(s) may become clogged (i.e., impeded, slowed) or plugged (i.e., obstructed, substantially or completely closed) by a viscous plug that forms in the nozzle(s) as a result of solvent loss, crusting of the ink, and/or kogation of various ink components in and/or around any of the nozzles. If a nozzle has become clogged, ink droplets ejected through the nozzle's orifice may be misdirected, which may adversely affect print quality. When an orifice is plugged, it becomes substantially or completely blocked. As a result of the nozzle being plugged, the ink droplets may not pass through the affected nozzle. Thus, the criteria for measuring failure to fire by a nozzle is a misdirection of ink through the nozzle's orifice to a lesser or greater degree, or a complete blockage, which can be measured by visually inspecting a printed image.

### Inkjet Inks

The present disclosure is directed to inkjet inks that possess suitable physical and chemical stability at both ambient temperatures and printhead operating temperatures, are jetted reliably, provide high image sharpness, and have prolonged decap times while still drying quickly after being applied onto a substrate (e.g., dry times of 30 seconds or less). The combination of ingredients disclosed herein has been surprisingly found to strike a balance between fast dry times and extended decap time, while also providing sharp images on non-porous substrates (e.g., films and foils).

Inkjet inks of the present disclosure generally include the following components: (A) a terpene resin, (B) a solvent system that includes (B1) methyl ethyl ketone, and (C) a polyether modified silicone having an HLB value of 1 to 12. The inkjet inks of the present disclosure may also optionally include one or more of (B2) acetone as part of the solvent system (B). (B3) a glycol ether as part of the solvent system (B), (D) a rosin resin. (E) a colorant, and (F) an additive.

### (A) Terpene Resin

The terpene resin (A) of the present disclosure refers to oligomers or polymers having at least 95 wt. %, preferably at least 96 wt. %, more preferably at least 97 wt. %, more preferably at least 98 wt. %, more preferably at least 99 wt. %, even more preferably at least 99.5 wt. %, yet even more preferably 100 wt. % of constitutional units derived from a polymerizable terpene(s), based on the total constitutional units (100 wt. %) of the terpene resin (A). Terpenes have a basic skeleton (C₅H₈), where p is a positive integer that delineates the number of isoprene units that are successively bound head to tail. For example, hemiterpenes (p=1) have a C₅H₈ skeleton, monoterpenes (p=2) have a C₁₀H₁₆ skeleton, sesquiterpenes (p=3) have a C₁₅H₂₄ skeleton, and so forth.

In some embodiments, the terpene resin (A) is based on monoterpene monomer units. The monoterpene may be a linear monoterpene (e.g., myrcene, ocimene, etc.), a monocyclic monoterpenes (e.g., limonene, γ-terpinene, α-phellandrene, β-phellandrene, terpinolene, etc.), or a bicyclic monoterpene (e.g., 3-carene, α-pinene, β-pinene, α-fenchene, camphene, etc.), including the various stereoisomers thereof, as well as mixtures thereof. In some embodiments, the monoterpene is a monocyclic monoterpene, with particular preference to limonene. In preferred embodiments, the monoterpene is a bicyclic monoterpene, with particular preference to 3-carene, α-pinene, β-pinene, and camphene, more preferably α-pinene and/or β-pinene, even more preferably α-pinene.

Preferred inkjet inks are those formulated with a terpene resins (A) made from polymerization or oligomerization of α-pinene. As known by those of ordinary skill in the art, such terpene resins may be readily obtained for example through catalytic polymerization/oligomerization (in solution) of α-pinene monomers, which are in turn typically derived from fractional distillation of gum and sulfate turpentines obtained from pines such as Pistacia terebinthus, Pinus pinaster, Pinus halepensis, Pinus massoniana, Pinus merkusii, Pinus palustris, Pinus taeda, and Pinus ponderosa.

In preferred embodiments, the terpene resin (A) is a homopolymer made from α-pinene, with an α-pinene content (constitutional units derived from α-pinene) of at least 95 wt. %, preferably at least 96 wt. %, more preferably at least 97 wt. %, more preferably at least 98 wt. %, more preferably at least 99 wt. %, even more preferably at least 99.5 wt. %, yet even more preferably 100 wt. %, based on the total constitutional units (100 wt. %) of the terpene resin (A). While the terpene resins (A) of the present disclosure may include small amounts of other constitutional units other than constitutional units derived from α-terpene monomers, the amount of other (e.g., non-terpene based) constitutional units is preferably less than 5 wt. %, more preferably less than 3 wt. %, more preferably less than 1 wt. %, even more preferably less than 0.5 wt. %, yet even more preferably 0 wt. %, based on the total constitutional units (100 wt. %) of the terpene resins (A).

In preferred embodiments, the terpene resin (A) is a homopolymer made from β-pinene, with a β-pinene content (constitutional units derived from β-pinene) of at least 95 wt. %, preferably at least 96 wt. %, more preferably at least 97 wt. %, more preferably at least 98 wt. %, more preferably at least 99 wt. %, even more preferably at least 99.5 wt. %, yet even more preferably 100 wt. %, based on the total constitutional units (100 wt. %) of the terpene resin (A). While the terpene resins (A) of the present disclosure may include small amounts of other constitutional units other than constitutional units derived from β-terpene monomers, the amount of other (e.g., non-terpene based) constitutional units is preferably less than 5 wt. %, more preferably less than 3 wt. %, more preferably less than 1 wt. %, even more preferably less than 0.5 wt. %, yet even more preferably 0 wt. %, based on the total constitutional units (100 wt. %) of the terpene resins (A).

Both polymeric and oligomeric forms of the terpene resin (A) may be used herein, including combinations thereof. Typically, terpene resins (A) are used herein that have a number average molecular weight (Mₙ) of at least 330 g/mol, preferably at least 340 g/mol, preferably at least 400 g/mol, preferably at least 450 g/mol, preferably at least 500 g/mol, preferably at least 550 g/mol, more preferably at least 600 g/mol, more preferably at least 650 g/mol, even more preferably at least 700 g/mol, yet even more preferably at least 750 g/mol, and up to 1,500 g/mol, preferably up to 1,300 g/mol, more preferably up to 1,100 g/mol, more preferably up to 1,000 g/mol, more preferably up to 900 g/mol, even more preferably up to 800 g/mol, yet even more preferably up to 790 g/mol.

The terpene resins (A) may be in the form of a solid or a liquid at room temperature. When in the form of a solid, the terpene resin (A) utilized herein may be categorized based upon its softening point (SP), for example according to a ring-and-ball softening point method. The ring-and-ball softening point is defined as the temperature at which a disk of the sample held within a horizontal ring is forced downward a distance of 1 in. (25.4 mm) under the weight of a steel ball as the sample is heated at a prescribed rate in a glycerol bath (e.g., according to JIS B7410, which is incorporated herein by reference in its entirety). In some embodiments, the terpene resin (A) has a softening point of at least 20° C., preferably at least 40° C., preferably at least 60° C., preferably at least 80° C., more preferably at least 100° C., more preferably at least 110° C. more preferably at least 115° C., more preferably at least 120° C., even more preferably at least 125° C., yet even more preferably at least 130° C., and up to 160° C. preferably up to 155° C., preferably up to 150° C. preferably up to 145° C., preferably up to 140° C. preferably up to 138° C., preferably up to 135° C.

Bromine number is the amount of bromine (Br₂) in grams absorbed by 100 grams of a sample, and is an indicator of the degree of unsaturation of the sample. In some embodiments, the terpene resin (A) employed in the inkjet inks has a bromine number of at least 12, preferably at least 15, preferably at least 19, preferably at least 22, preferably at least 25, preferably at least 26, more preferably at least 27 and up to 35, preferably up to 34, more preferably up to 33, more preferably up to 32, even more preferably up to 31, yet even more preferably up to 30, although terpene resins (A) having a bromine number above or below (e.g., hydrogenated terpene resins (A)) these values may also find use in the disclosed inkjet inks.

The terpene resin (A) may be present in the inkjet inks in an amount of at least 0.1 wt. %, preferably at least 0.5 wt. %, more preferably at least 1 wt. %, more preferably at least 1.5 wt. %, more preferably at least 2 wt. %, even more preferably at least 2.5 wt. %, yet even more preferably at least 3 wt. %, and up to 10 wt. %, preferably up to 9 wt. %, preferably up to 8 wt. %, preferably up to 7 wt. %, more preferably up to 6 wt. %, even more preferably up to 5 wt. %, yet even more preferably up to 4 wt. %, based on a total weight of the inkjet ink.

The inkjet inks of the present disclosure may be formulated with a single type of terpene resin (A), or with a combination of two or more types of terpene resins (A). Examples of terpene resins (A) that may be employed in the inkjet inks herein, either alone or in combination, include, but are not limited to, PICCOLYTE A115 (ring-and-ball SP=112-118° C., bromine number=31.5), PICCOLYTE A125 (ring-and-ball SP=122-128° C., bromine number=31.5), PICCOLYTE A135 (ring-and-ball SP=132-138° C., bromine number=27), PICCOLYTE A135 PLUS (ring-and-ball SP=132-138° C.), PICCOLYTE AO PLUS (oligomer, liquid), and PINOVA RESIN 2495 (ring-and-ball SP=132-138° C., bromine number=27), each being made from high purity α-pinene, available from Pinova, as well as PICCOLYTE S25 (made from high purity β-pinene, ring-and-ball SP=22-28° C., bromine number 19), available from Pinova.

It has been unexpectedly discovered that inkjet inks which are formulated with a terpene resin (A) possess superior dry times and decap times (see e.g., Tables 1 and 6, Examples 3-11), compared with inkjet inks in which the terpene resin (A) is replaced with other binder resins/tackifiers/adhesive substance (e.g., a terpene phenol resin such as DERTOPHENE T, a rosin resin for example a hydrogenated acidic rosin such as FORAL AX, each available from Pinova etc.), which tend to suffer from poor (i.e., short) decap times with nozzle misfirings occurring in 30 seconds or less after decapping (see e.g., Tables 2 and 7, Examples 13 and 14).

### (B) Solvent System

In many printing processes that utilize solvent-based inks, and particularly in thermal inkjet printing, the selection of an appropriate solvent system may impact the reliability of the printing process, the properties/appearance of the printed ink product, and the overall printing process efficiency. For example in thermal inkjet printing, the choice of solvent system may 1) aid bubble formation during the jetting process resulting in reliable ink jetting, 2) affect the stability/volatility of the inkjet inks by changing the interaction dynamics between the solvent(s) and the various inkjet ink components and thus the decap behavior, kogation, and/or drop trajectory, 3) impact the adhesion, rub and scratch resistance, and optical density properties of the printed image through the interactive forces between the solvent system and the other inkjet ink components even though the solvent(s) may no longer be present, or may be present in lesser amounts, after drying, and/or 4) influence the drying time after application or the equipment needed to dry the applied ink.

In light of the above, particular preference is given herein to inkjet inks with a solvent system (B) that includes (B1) methyl ethyl ketone (MEK). The inclusion of methyl ethyl ketone (B1) may aid solvation of the inkjet ink components and provide the inkjet inks with acceptable volatility for the purposes of dry times. It is preferred that methyl ethyl ketone (B1) constitutes a majority of the solvent system used in the inkjet inks herein, i.e., that MEK (B1) constitutes at least 50 wt. %, preferably at least 55 wt. %, preferably at least 60 wt. %, more preferably at least 65 wt. %, even more preferably at least 70 wt. %, yet even more preferably at least 75 wt. %, and up to 100 wt. %, preferably up to 95 wt. %, more preferably up to 90 wt. %, even more preferably up to 85 wt. %, yet even more preferably up to 80 wt. %, based on a total weight of the solvent system (B). In some embodiments, methyl ethyl ketone (B1) is present in the inkjet inks in an amount of at least 40 wt. %, preferably at least 45 wt. %, more preferably at least 50 wt. %, more preferably at least 55 wt. %, even more preferably at least 60 wt. %, yet even more preferably at least 65 wt. %, and up to 90 wi. %, preferably up to 88 wt. %, preferably up to 85 wt. %, more preferably up to 80 wt. %, more preferably up to 75 wt. %, even more preferably up to 70 wt. %, yet even more preferably up to 67 wt. %, based on a total weight of the inkjet ink.

In some embodiments, a weight ratio of the methyl ethyl ketone (B1) to the terpene resin (A) ((B1):(A)) is at least 10:1, preferably at least 14:1, preferably at least 16:1, preferably at least 18:1, preferably at least 20:1, more preferably at least 22:1, even more preferably at least 24:1, yet even more preferably at least 26:1, and up to 100:1, preferably up to 80:1, preferably up to 60:1, preferably up to 50:1, preferably up to 40:1, more preferably up to 35:1, even more preferably up to 34:1, yet even more preferably up to 32:1.

Besides methyl ethyl ketone (B1), additional ketone solvents such as those containing 3 to 6 carbon atoms may be optionally included in the solvent system (B) herein. Examples of (non-MEK) ketone solvents include, but are not limited to, acetone, 3-pentanone, methyl n-propyl ketone, methyl isopropyl ketone, methyl n-butyl ketone, methyl isobutyl ketone, and cyclohexanone. Preferably, the inkjet inks have a total ketone content of at least 50 wt. %, preferably at least 55 wt. %, more preferably at least 60 wt. %, more preferably at least 62 wt. %, even more preferably at least 64 wt. %, yet even more preferably at least 66 wt. %, and up to 95 wt. %, preferably up to 92 wt. %, more preferably up to 90 wt. %, more preferably up to 88 wt. %, even more preferably up to 86 wt. %, yet even more preferably up to 84 wt. %, based on a total weight of the inkjet inks. The “total ketone content” above refers to the total amount of ketone-based solvents employed in the inkjet inks, represented as a percentage based on a total weight of the inkjet ink. Thus, when MEK (B1) is used alone without any additional ketone solvents, the total ketone content represents the amount of MEK (B1) present in the inkjet inks, and when MEK (B1) is used in combination with one or more additional ketone solvents (e.g., acetone), the total ketone content represents the total sum of MEK (B1) plus additional ketone solvent(s).

In particular, extremely fast drying times and advantageous decap times may be realized when the solvent system (B) further includes (B2) acetone. For example, when formulated to include acetone (B2), the inkjet ink may have an acetone (B2) content of at least 1 wt. %, preferably at least 5 wt. %, more preferably at least 10 wt. %, even more preferably at least 15 wt. %, yet even more preferably at least 20 wt. %, and up to 40 wt. %, preferably up to 35 wt. %, more preferably up to 30 wt. %, even more preferably up to 25 wt. %, based on a total weight of the inkjet ink.

When acetone (B2) is present, the weight ratio of methyl ethyl ketone (B1) to acetone (B2) can be adjusted for desired drying times and decap times, but typically the weight ratio of methyl ethyl ketone (B1) to acetone (B2) ((B1):(B2)) ranges from at least 1:1, preferably at least 2:1, preferably at least 3:1, preferably at least 3.2:1, and up to 5:1, preferably up to 4:1, preferably up to 3.5:1.

The solvent system (B) may also optionally include a glycol ether (B3) to further improve decap performance without substantially worsening ink dry times. The glycol ether (B3) may be a monoalkyl ether, a dialkyl ether, a monoalkyl monoester ether, or a combination thereof. In preferred embodiments, the glycol ether (B3) is a monoalkyl ether, i.e., contains one free hydroxyl group. The glycol ether (B3) may contain preferably at least 3 carbon atoms, more preferably at least 4 carbon atoms, and up to 12 carbon atoms, preferably up to 10 carbon atoms, more preferably up to 8 carbon atoms. Acceptable examples of glycol ethers (B3) that may be optionally included in the disclosed inkjet inks include, but are not limited to, ethylene glycol monomethyl ether, ethylene glycol monoethyl ether, ethylene glycol mono-isopropyl ether, ethylene glycol mono-n-propyl ether, ethylene glycol mono-t-butyl ether, ethylene glycol monobutyl ether, ethylene glycol mono-isobutyl ether, diethylene glycol monomethyl ether, propylene glycol monomethyl ether, propylene glycol monoethyl ether, propylene glycol mono-t-butyl ether, propylene glycol mono-n-propyl ether, propylene glycol mono-isopropyl ether, propylene glycol mono-n-butyl ether, dipropylene glycol monomethyl ether, propylene glycol methyl ether acetate, ethylene glycol dimethylether, diethylene glycol dimethylether, diethylene glycol methyl ethyl ether, diethylene glycol diethylether, dipropylene glycol dimethyl ether, dipropylene glycol mono-n-propyl ether, as well as mixtures thereof.

When employed, the glycol ether (B3) may be present in the inkjet inks in an amount of at least 1 wt. %, preferably at least 5 wt. %, more preferably at least 10 wt. %, even more preferably at least 15 wt. %, yet even more preferably at least 20 wt. %, and up to 40 wt. %, preferably up to 35 wt. %, more preferably up to 30 wt. %, even more preferably up to 25 wt %, based on a total weight of the inkjet ink.

In terms of improving decap performance of the inkjet inks without considerably lengthening ink dry times, preferred glycol ethers (B3) are those which have a boiling point (at standard pressure) of less than 214° C., preferably less than 200° C., preferably less than 190° C., preferably less than 180° C., more preferably less than 175° C., more preferably less than 170° C., more preferably less than 165° C., more preferably less than 160° C., even more preferably less than 155° C., yet even more preferably less than 150° C.

In light of the above, preference is given to glycol ethers (B3) selected from the group consisting of ethylene glycol monomethyl ether, propylene glycol monomethyl ether, propylene glycol mono-n-propyl ether, and dipropylene glycol mono-n-propyl ether, including mixtures thereof, with particular preference given to propylene glycol mono-n-propyl ether.

In addition to methyl ethyl ketone (B1), and optionally additional ketone solvents (e.g., acetone (B2)) and/or glycol ethers (B3), other organic solvents which may be optionally utilized as part of the solvent system (B) herein include, but are not limited to:
lower alcohols containing from 1 to 8 carbon atoms, such as methanol, ethanol, 1-propanol, 2-propanol, 1-butanol, 2-butanol;
ethers (non-glycol ethers), for example ethers containing 4 to 8 carbon atoms such as diethyl ether, dipropyl ether, methyl tert-butyl ether, dibutyl ether, dioxane, and tetrahydrofuran;
esters, including those having 3 to 8 carbon atoms, for example methyl acetate, ethyl acetate, n-butyl acetate, methyl lactate, ethyl lactate:
and the like, as well as mixtures of two or more thereof.

When present, the additional organic solvents may be included in amounts of up to 20 wt. %, preferably up to 15 wt. %, preferably up to 10 wt. %, preferably up to 5 wt. %, more preferably up to 4 wt. %, even more preferably up to 2 wt. %, yet even more preferably up to 1 wt. %, based on a total weight of the inkjet inks.

In general, preferred inkjet inks are those which are substantially free of solvents having a boiling point higher than 175° C., preferably solvents having a boiling point higher than 170° C., preferably solvents having a boiling point higher than 165° C., more preferably solvents having a boiling point higher than 160° C., even more preferably solvents having a boiling point higher than 155° C.

In some embodiments, the inkjet inks are substantially free of lower alcohol solvents (having 1 to 8 carbon atoms). In some embodiments, the inkjet inks are substantially free of ether solvents (other than glycol ethers (B3)). In some embodiments, the inkjet inks are substantially free of glycol ethers (B3). In some embodiments, the inkjet inks are substantially free of ketone solvents (other than MEK), in particular, acetone (B2). In some embodiments, the inkjet inks are substantially free of ester solvents. In some embodiments, the inkjet inks are substantially free of additional organic solvents, that is, organic solvents other than methyl ethyl ketone (B1), additional ketone solvents (e.g., acetone (B2)), and glycol ethers (B3). In preferred embodiments, the solvent system (B) consists of methyl ethyl ketone (B1) and one of acetone (B2) or a glycol ether (B3).

In preferred embodiments, the inkjet inks of the present disclosure are substantially non-aqueous, meaning that no water is added to the inkjet inks other than what may be incidental amounts of moisture derived from ambient conditions. In such cases, the inkjet inks may have less than 1 wt. %, preferably less than 0.5 wt. %, preferably less than 0.1 wt. %, preferably less than 0.05 wt. %, preferably less than 0.01 wt. % of water, more preferably 0 wt. %, based on the total weight of inkjet inks.

### Polyether Modified Silicone (C)

The inkjet inks of the present disclosure are formulated with a specific surfactant, namely a polyether modified silicone (C). In particular, suitable image sharpness is achievable when a polyether modified silicone (C) is employed having a hydrophilic-lipophilic balance (HLB) value according to Griffin's method of at least 1, preferably at least 2, preferably at least 3, more preferably at least 4, even more preferably at least 4.5, yet even more preferably at least 5, and up to 12, preferably up to 11, preferably up to 10, preferably up to 9, more preferably up to 8, even more preferably up to 7, yet even more preferably up to 6.

The polyether modified silicone (C) utilized in the disclosed inkjet inks is preferably a block copolymer having a pendent graft structure, which comprises or consists of (i) a silicone backbone (main chain) and (ii) one or more polyether side chains attached to the silicone backbone, and optionally (iii) one or more fatty alkyl side chains attached to the silicone backbone. Therefore, as long as at least one polyether side chain is attached to a silicone backbone, the material meets the definition of a “polyether modified silicone (C)” regardless of whether additional side chain types (e.g., fatty alkyl side chains) are also attached to the silicone backbone. Preferably, no other side chains, besides the polyether side chain(s) and optionally the fatty alkyl side chain(s) are present in the polyether modified silicone (C). As referred to herein, “side chains” are not continuations of the silicone backbone as would be the case in linear block copolymers, for example of A-B-A structure but instead are attached to the silicone backbone (main chain) as pendent grafts thereby forming a branching point on the silicone backbone with the side chains extending from the silicone backbone via covalent bonds. Preferred polyether modified silicones (C) are those which are non-hydrolyzable, that is, where the side chains are attached to the silicone backbone via Si—C bonds.

<(i) silicone backbone> The silicone backbone may be based on any organosilicon polymer or oligomer (polyorganosiloxane) of linear or branched structure, of variable molecular weight, which can be formed from polymerization and/or polycondensation of suitably functionalized silanes, and which has a polysiloxane backbone structure (silicon atoms are linked together via oxygen atoms, —Si—O—Si—), with alkyl, aryl, and/or arylalkyl groups directly bonded to the (tetravalent) silicon atoms. For example, the polyorganosiloxane backbone may be a linear structure including, but not limited to, a polydimethylsiloxane (dimethicone) backbone (where each silicon atom in the backbone is directly bonded to two methyl groups), a poly(dimethylsiloxane-co-methylphenylsiloxane) backbone, a poly(dimethylsiloxane-co-diphenylsiloxane) backbone, and a poly(dimethylsiloxane-co-methylalkylsiloxane) backbone; or a branched structure with specific mention being made to a polydimethylsiloxyethyl dimethicone.

<(ii) polyether side chain> The polyether modified silicone (C) contains at least one polyether side chain, which is based on a polyalkylene glycol oligomer or polymer, for example those formed from ring opening polymerization of one or more alkylene oxides, with ethylene oxide (EO), propylene oxide (PO), and/or butylene oxide (BO) being the most preferred, including copolymers such as block copolymers thereof. Preferably, the polyether side chain is a polyethylene glycol or a polyethylene glycol-polypropylene glycol copolymer which extends from the silicone backbone, more preferably the polyether side chain is a polyethylene glycol side chain (formed from only ethylene oxide, EO).

Various lengths of polyether side chain(s) may be utilized so long as the HLB value of the polyether modified silicone (C) stays within the range provided above. Typically, the is number of moles of alkylene oxide units per side chain ranges from at least 2, preferably at least 3, more preferably at least 4, even more preferably at least 5, yet even more preferably at least 6, and up to 50, preferably up to 40, preferably up to 30, preferably up to 20, preferably up to 15, more preferably up to 12, even more preferably up to 10, yet even more preferably up to 9, with particular preference given to 3 to 10 moles, preferably 4 to 9 moles of ethylene oxide (EO) units per side chain.

Moreover, any polyether side chain present may be uncapped (whereby the end of the polyether side chain opposite of the silicone backbone terminates in —H, forming a terminal hydroxyl functional group) or may be capped with an alkyl group having 1, 2, 3, or 4 carbon atoms (forming a terminal alkyl ether group), with specific mention being made to methyl, ethyl, propyl, and butyl. In preferred embodiments, the polyether modified silicone (C) contains only uncapped polyether side chains, i.e., each polyether side chain contains a terminal hydroxyl group.

<(iii) fatty alkyl side chain> The polyether modified silicone (C) may optionally also be modified with one or more fatty alkyl side chains, such as those containing at least 8 carbon atoms, preferably at least 10 carbon atoms, more preferably at least 12 carbon atoms, and up to 22 carbon atoms, preferably up to 20 carbon atoms, more preferably up to 18 carbon atoms, even more preferably up to 16 carbon atoms, yet even more preferably up to 14 carbon atoms. Exemplary fatty alkyl side chain groups include, but are not limited to, capryl, nonyl, decyl, undecyl, lauryl, tridecyl, myristyl, pentadecyl, cetyl, palmitoleyl, heptadecyl, stearyl, oleyl, arachidyl, and behenyl, with specific mention being made to lauryl, myristyl, cetyl, and stearyl, preferably lauryl.

In some embodiments, the polyether modified silicone (C) has a kinematic viscosity at 25° C. of at least 120 mm²/s, preferably at least 130 mm²/s, more preferably at least 140 mm²/s, even more preferably at least 150 mm²/s, yet even more preferably at least 160 mm²/s, and up to 1,000 mm²/s, preferably up to 950 mm²/s, preferably up to 900 mm²/s, preferably up to 850 mm²/s, more preferably up to 800 mm²/s, even more preferably up to 750 mm²/s, yet even more preferably up to 700 mm²/s.

The polyether modified silicone (C) may provide the desired image sharpness effects, without sacrificing decap time, when employed in the inkjet ink in amounts of at least 0.001 wt. %, preferably at least 0.005 wt. %, preferably at least 0.01 wt. %, preferably at least 0.02 wt. %, more preferably at least 0.03 wt. %, even more preferably at least 0.04 wt. %, yet even more preferably at least 0.05 wt. %, and up to 4 wt. %, preferably up to 3.5 wt. %, preferably up to 3 wt. %, preferably up to 2.5 wt. %, preferably up to 2 wt. %, preferably up to 1.5 wt. %, preferably up to 1 wt. %, preferably up to 0.8 wt. %, preferably up to 0.5 wt. %, more preferably up to 0.3 wt. %, even more preferably up to 0.2 wt. %, yet even more preferably up to 0.1 wt. %, based on a total weight of the inkjet ink.

In some embodiments, the polyether modified silicone (C) is a block copolymer having a pendent graft structure formed from a linear polydimethylsiloxane backbone containing one or more polyether side chains, for example as represented by formula (I-A)

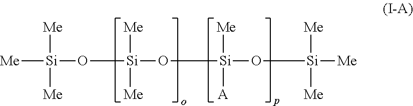

where:
o is 0 or a positive integer, for example at least 1, preferably at least 2, more preferably at least 3, even more preferably at least 4, yet even more preferably at least 5, and up to 500, preferably up to 400, preferably up to 300, more preferably up to 200, even more preferably up to 100, yet even more preferably up to 50;
p represents the number of constitutional units containing the polyether side chain, and is a positive integer, for example at least 1, preferably at least 2, more preferably at least is 3, even more preferably at least 4, yet even more preferably at least 5, and up to 100, preferably up to 80, preferably up to 60, more preferably up to 40, even more preferably up to 20, yet even more preferably up to 10; and

A is a polyether containing group represented by formula (II)

—(CH₂)_{w}—O—(CH₂CH₂O)ₙ—(CH₂CH(CH₃)O)ₘ—Z (II)
where
w is at least 2, preferably at least 3, and up to 6, preferably up to 5, more preferably up to 4, even more preferably w is 3;
n is 0 or an integer of at least 1, preferably at least 2, more preferably at least 3, even more preferably at least 4, and up to 30, preferably up to 20, more preferably up to 10, even more preferably up to 9, yet even more preferably n is 3 to 10;
m is 0 or an integer of up to 30, preferably up to 10, preferably up to 9, preferably up to 5, more preferably up to 2, even more preferably up to 1, yet even more preferably m is 0; and
Z is H or an alkyl group having 1 to 4 carbon atoms, preferably H (uncapped).

Suitable examples of this type of polyether modified silicone (C) which may be employed in the disclosed inkjet inks include, but are not limited to, KF-6013 (PEG-9 dimethicone, uncapped, HLB=10.0), KF-6015 (PEG-3 dimethicone, uncapped, HLB=4.5), and KF-6017 (PEG-10 dimethicone, uncapped, HLB=4.5), each available from Shin-Etsu Chemical Co.

In some embodiments, the polyether modified silicone (C) is a block copolymer having a pendent graft structure formed from a branched polydimethylsiloxane backbone containing one or more polyether side chains and one or more fatty alkyl side chains, for example as represented by formula (I-B)

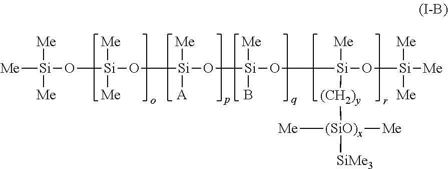

where:
o, p, and A are as described above;
B is a fatty alkyl group, preferably a fatty alkyl group having at least 10 carbon atoms, preferably at least 12 carbon atoms, and up to 18 carbon atoms, preferably at least 16 carbon atoms, preferably at least 14 carbon atoms, with specific mention being made to lauryl, myristyl, cetyl, and stearyl;
q represents the number of constitutional units containing the fatty alkyl side chain, and is a positive integer, for example at least 1, preferably at least 2, more preferably at least 3, even more preferably at least 4, yet even more preferably at least 5, and up to 50, preferably up to 40, preferably up to 30, more preferably up to 20, even more preferably up to 10, yet even more preferably up to 5;
r represents branching in the polydimethylsiloxane backbone, and is a positive integer, for example a positive integer of up to 50, preferably up to 40, preferably up to 30, preferably up to 20, preferably up to 10, preferably up to 5, more preferably up to 3, even more preferably up to 2, yet even more preferably 1;
x is a positive integer, for example at least 1, preferably at least 2, more preferably at least 3, even more preferably at least 4, yet even more preferably at least 5, and up to 200, preferably up to 150, preferably up to 100, more preferably up to 75, even more preferably up to 50, more preferably up to 30, even more preferably up to 20, yet even more preferably up to 10; and
y is at least 2 and up to 6, preferably 2.

A suitable example of this type of polyether modified silicone (C) which may be employed in the disclosed inkjet inks includes, but is not limited to, KF-6038 (Lauryl PEG-9 polydimethylsiloxyethyl dimethicone, uncapped, HLB=3.0), available from Shin-Etsu Chemical Co.

As will become clear, it has been unexpectedly discovered that a specific type of surfactant the polyether modified silicone (C) having an HLB value of 1 to 12, and preferably with a pendent graft structure with uncapped polyether side chains enables the production of desirable image sharpness even when printing on ‘difficult’ non-porous substrates such as varnish coated paper, biaxially oriented polypropylene (BOPP), polyethylene terephthalate (PET), nylon, aluminum, and the like (see e.g., Tables 1, 2, 6, and 7, Examples 3-11, 15, and 17-19). Without being bound by theory, it is believed that the polyether side chain(s) of the polyether modified silicone (C) adsorb onto/orient towards the substrate surface while the silicone backbone orients away from the substrate surface thereby rendering the substrate surface more hydrophobic for the solvent(s) and any other inkjet ink components, thus preventing excessive spreading of the inkjet ink upon application. It is this interaction between the polyether modified silicone (C) and the substrate surface that is believed to enable the production of high image sharpness, with the HLB value providing a balance between vehicle solubility and substrate adsorption.

On the other hand, it has been found that polyether modified silicones having an HLB value of outside of the 1 to 12 range, as well as other types of surfactants, including silicone acrylate copolymers and other surfactants common to inkjet inks (see e.g., US 2018/0251650, US 2017/0037269 and US 2015/0291816—each incorporated herein by reference in its entirety), fail to provide acceptable image sharpness when used instead of polyether modified silicones having an HLB value of 1 to 12 (see e.g., Tables 1 and 6, Examples 2 and 12).

Examples of these other surfactant types include, but are not limited to,
polysiloxanes including organomodified silicones (e.g., alkyl, aryl, and/or arylalkyl modified silicones) such as SILTECH C-32, available from Siltech Corporation, COATOSIL 1211C and 3573, each available from Momentive, KF-410 (an arylalkyl-modified polydimethylsiloxane), available from Shin-Etsu Chemical Co., and BYK-322 and BYK-323 (arylalkyl-modified poly(dimethylsiloxane-co-methylalkylsiloxane)), each available from BYK Additives & Instruments;
silicone acrylate copolymers such as KP-541, KP-543, KP-545, KP-550, and KP-575 (acrylic polymers grafted with polydimethylsiloxane side chains, available from Shin-Etsu Chemical Co., Ltd.), and BYK-3550 (available from BYK Japan K.K.);
photo-cross-linkable silicone acrylates or silicone polyether acrylates such as TEGO RAD 2100, TEGO RAD 2200, TEGO RAD 2250, TEGO RAD 2300 (silicone polyether acrylate), each available from Evonik Industries, and BYK-UV 3500 and 3530, available from BYK;
polyacrylates including polyacrylate copolymers and cross-polymers such as BYK-381 and BYK-361N (polyacrylate copolymer), each available from BYK, PEMULEN EZ-4U (acrylate/C10-C30 alkyl acrylate crosspolymer) and PEMULEN TR-2 (acrylic acid/C10-C30 alkyl acrylate crosspolymer), each available from Lubrizol;
fluoropolymers such as FC-4430 and FC-4432, available from 3M Corporation;
acetylenic diol and acetylenic glycol-based gemini surfactants such as SURFYNOL SEF and DYNOL surfactants, available from Evonik Industries;
polysiloxane-based gemini surfactants such as TEGO TWIN 4100, available from Evonik Industries;
non-ionic polyethers for example as substrate wetting surfactants such as TEGO WET 510 (hydrophilic polyether substrate wetting surfactant), available from Evonik Industries;
amides or monoalkanolamides of fatty acids, including alkoxylated monoalkanolamides of fatty acids such as coconut fatty acid monoethanolamide and coconut fatty acid monoethanolamide reacted with 2-20 moles of ethylene oxide;
ethers, such as alkoxylated Ci-Cu alcohols including alkoxylated fatty alcohols such as BIO-SOFT N-600 (C12-C13 alcohol ethoxylate). MAKON DA-4 (ethoxylated isodecyl alcohol), MERPOL SE (alcohol ethoxylate), and POLYSTEP TD-6 (ethoxylated tridecyl alcohol), each available from Stepan, ethylene oxide/propylene oxide copolymers, alkoxylated alkylphenols, and alkyl polyglycosides (APGs) such as those made from reaction between fatty alcohols and glucose;
fatty esters such as ethoxylated and/or propoxylated fatty acids (e.g., castor oil with 2 to 40 moles of ethylene oxide), alkoxylated glycerides (e.g., PEG-24 glyceryl monostearate), glycol esters and derivatives, monoglycerides, polyglyceryl esters, esters of polyalcohols, and sorbitan/sorbitol esters like sorbitan monolaurate (e.g., EMASOL L-10V, available from Kao) and polysorbates including mono-, bi- or tri-fatty acid esterified polysorbates such as TOXIMUL SEE-340 (sorbitan trioleate ethoxylate (20)), available from Stepan; and
glycosides of fatty alcohols such as PLANTASENS NATURAL EMULSIFIER HE20 (cetearyl glucoside, sorbitan olivate), available from Clariant.

While other types of surfactants are not necessarily excluded from use in the disclosed inkjet inks, their optional use is to be accompanied by the polyether modified silicone (C) for acceptable image sharpness. However, preferred inkjet inks are those in which the polyether modified silicone (C) is the only surfactant present.

### Rosin Resin (D)

The inkjet inks may be optionally formulated with a rosin resin (D). Any rosin resin (D) that is compatible with the terpene resin (A), methyl ethyl ketone (B1), and the polyether modified silicone (C) may be utilized herein, including rosin resins (D) derived from gum rosin, wood rosin, and tall oil rosin (the main components of which are resin acids such as abietic acid, palustric acid, neoabietic acid, pimaric acid, isopimaric acid and/or dehydroabietic acid), preferably rosin resins (D) derived from wood rosin. When employed, the rosin resin (D) may be used in an amount of up to 10 wt. %, for example at least 0.5 wt. %, preferably at least 1 wt. %, more preferably at least 1.5 wt. %, more preferably at least 2 wt. %, even more preferably at least 2.5 wt. %, yet even more preferably at least 3 wt. %, and up to 10 wt. %, preferably up to 8 wt. %, more preferably up to 6 wt. %, even more preferably up to 5 wt. %, yet even more preferably up to 4 wt. %, based on a total weight of the inkjet ink. When the inkjet inks are formulated with rosin resin (D), it is preferred that the amount (in terms of weight %) of rosin resin (D) is less than or equal to the amount of terpene resin (A).

The rosin resin (D) may be formed by modifying the aforementioned rosins through esterification, hydrogenation (including partial hydrogenation), dimerization, and/or other modifications/functionalization for example through Diels-Alder reaction with an unsaturated di-acid (e.g., maleic or fumaric acid/anhydride), carboxylic acid reduction to the respective aldehydes/alcohols, double bond isomerization, dehydrogenation, oxidation, disproportionation, and the like. Exemplary rosin resins (D) include, but are not limited to:
a rosin ester resin, such as e.g., an ester of a rosin composed mainly of an abietic type or pimaric type resin acid that has been reacted with an alcohol(s) such as glycerin, pentaerythritol, ethylene glycol, diethylene glycol, triethylene glycol, methanol, etc., and optionally hydrogenated or partially hydrogenated, with specific mention being made to HARIESTER products available from Harima Chemicals, Inc., STAYBELITE ESTER 10-E and PERMALYN 6110, each available from Eastman, SUPER ESTER A-125, SUPER ESTER A-75, PENSEL D-125, PINECRYSTAL KE-359 available from Arakawa Chemical Industries, Ltd., and FORAL 85, FORAL 105, HERCOLYN products, PEXALYN products, and PENTALYN products available from Pinova;
a hydrogenated acidic rosin such as FORAL AX and FORAL DX, each available from Pinova
a partially hydrogenated acidic rosin such as STAYBELITE RESIN-E, available from Eastman, and STAYBELITE and STAYBELITE A, each available from PINOVA;
a dimerized rosin such as POLY-PALE partially dimerized rosin available from Eastman; and
a functionalized rosin resin, for example an ester (e.g., glycerol ester) of a rosin which has been modified with maleic anhydride or a rosin which has been subject to carboxylic acid reduction conditions, with specific mention being made to LEWISOL 28-M and Abitol-E hydroabietyl alcohol, each available from Eastman;
and mixtures thereof.

In some embodiments, the rosin resin (D) has a softening point (ring-and-ball SP) of at least 50° C. preferably at least 55° C., more preferably at least 60° C., even more preferably at least 65° C., and up to 80° C., preferably up to 75° C., more preferably up to 70° C., even more preferably up to 68° C. In some embodiments, the rosin resin (D) is an acidic rosin (non-esterified) and has an acid number (in mg KOH/g) of at least 100, preferably at least 110, more preferably at least 120, more preferably at least 130, even more preferably at least 140, yet even more preferably at least 150, and up to 170, preferably up to 165, more preferably up to 160, even more preferably up to 158.

In preferred embodiments, the rosin resin (D) is a hydrogenated acidic rosin, preferably a hydrogenated acidic wood rosin, for example FORAL AX and FORAL DX, each available from Pinova. In some embodiments, the inkjet inks are substantially free of rosin resins (D). In some embodiments, the inkjet inks are substantially free of rosin ester resins, partially hydrogenated acidic rosins, dimerized rosins, and other functionalized/modified rosin resins. In some embodiments, a hydrogenated acidic rosin is the only rosin resin (D) present in the inkjet inks.

### Other Binder Resins

In addition to the terpene resin (A), and any optional rosin resin (D), the inkjet inks may optionally contain other binder resins/tackifiers/adhesive substances in an amount of at least 0.1 wt. %, preferably at least 0.5 wt. %, preferably at least 1 wt. %, preferably at least 1.5 wt. %, preferably at least 2 wt. %, preferably at least 2.5 wt. %, and up to 10 wt. %, preferably up to 9 wt. %, preferably up to 8 wt. %, preferably up to 7 wt. %, preferably up to 6 wt. %, preferably up to 5 wt. %, preferably up to 4 wt. %, preferably up to 3 wt. %, based on a total weight of the inkjet ink. Such additional resins, binders, tackifiers, or adhesive substances may include, but are not limited to,
terpene phenol resins (TPR), which are the copolymeric reaction products from alkylation of (i) one or more mono- or polyvalent phenolic compounds having at least two replaceable hydrogen atoms in ortho- and/or para-positions with respect to at least one hydroxyl group with (ii) one or more terpenes; such as those formed from copolymerization of (i) one or more phenolic compounds such as phenol, o-cresol, m-cresol, p-cresol, 2,5-xylenol, 2,3-xylenol, 3,4-xylenol, 3,5-xylenol, 2,3,5-trimethylphenol, isopropylphenol (e.g., 4-isopropylphenol), tert-butylphenol (e.g., 4-tert-butylphenol), amylphenol (e.g., 4-tert-amylphenol), heptylphenol (e.g., 4-heptylphenol), octylphenol (e.g., o-octylphenol, p-octylphenol, etc.), nonylphenol (e.g., 4-(2,4-dimethylheptan-3-yl)phenol), decylphenol, dodecylphenol, diphenylolpropane (bisphenol-A), phenylphenol (e.g., 3-phenylphenol), cumylphenol, mequinol, benzyloxyphenol, guaiacol, ethoxyphenol (e.g., 4-ethoxyphenol), resorcinol, pyrogallol, catechol, p-hydroquinone, 1-naphthol, and/or 2-naphthol, with (ii) one or more terpene monomers including linear monoterpenes (e.g., myrcene, ocimene, etc.), monocyclic monoterpenes (e.g., limonene, γ-terpinene, α-phellandrene, β-phellandrene, terpinolene, etc.), and/or bicyclic monoterpenes (e.g., 3-carene, α-pinene, β-pinene, α-fenchene, camphene, etc.); with specific mention being made to U130 POLYSTER (hydroxyl value (OHV)=25 mgKOH/g), U115 POLYSTER (OHV=30 mgKOH/g), T160 POLYSTER (OHV=60 mgKOH/g), T145 POLYSTER (OHV=65 mgKOH/g), available from Yasuhara Chemical Co. Ltd., and DERTOPHENE T (OHV=40 mgKOH/g), DERTOPHENE T160 (OHV=60 mgKOH/g), available from Pinova;
phenol resins (i.e. copolymers of phenolic compounds with formaldehyde), for example novolak resins such as PHENOLITE TD-2131 and PHENOLITE TD-2090 available from DIC Corp.;
polyamide resins, for example VERSAMID 725, 744, 756, 759 available from BASF Japan Ltd., TOHMIDE 90, 92, 394-N available from Sanho Chemical Co. Ltd., and SUNMIDE 550, 554, 615A, 638, 640 available from Evonik;
epoxy resins including sulfonamide-modified epoxy resins for example AD-PRO MTS available from Rit-Chem;
(meth)acrylate and styrene/(meth)acrylate resins for example JONCRYL 63, JONCRYL 67, JONCRYL 586, JONCRYL 611, JONCRYL 682, JONCRYL 693, available from BASF, PARALOID DM-55 and PARALOID B-66, available from Palmer Holland, PARALOID B-72, available from Dow Chemical, USA, and ELVACITE 2013, available from Lucite Inc.;
polyurethane resins, such as those formed from reaction between (i) polyols including, but not limited to, ethylene glycol, propylene glycol, propanediol, butanediol, polyethylene glycol, polypropylene glycol, polytetrahydrofuran diol, 3-methyl-1,5-pentanediol, 1,9-nonanediol, polyester polyols such as polyethylene glycol adipate diol, polyethylene glycol succinate diol, poly(3-methyl-1,5-pentanediol adipate) glycol, poly(3-methyl-1,5-pentanediol terephthalate) glycol, carbonate polyols, and (ii) diisocyanates including, but not limited to, 2,4-toluene diisocyanate, 2,6-toluene diisocyanate, 4,4-diphenylmethane diisocyanate, hexamethylene diisocyanate, and isophorone diisocyanate: for example PERMAX 200, PERMAX 202, and SANCURE 20025F, available from Lubrizol;
polyvinyl butyral resins, for example PIOLOFORM BN 16 and MOWITAL B20H available from Kuraray America, Inc.;
polyhydroxystyrene resins such as poly(p-hydroxy styrene) from DuPont;
vinyl resins, for example UCAR VYHH, VMCH, VMCA, and VAGF, available from Dow Chemical Company, and VINNOL E15/45, H14/36, E15/45M, and E16/40A, available from Wacker Chemie AG, Germany;
sulfonamide modified formaldehyde resins such as p-toluene sulfonamide formaldehyde resin;
cellulose ester resins such as cellulose acetate butyrate (CAB-551-0.01) available from Eastman;
as well as polyesters, sulfonated polyesters, cellulose ethers, cellulose nitrate resins, polymaleic anhydrides, acetal polymers, styrene/butadiene copolymers, melamine formaldehyde resins, sulfonamide-modified melamine formaldehyde resins, ketone-aldehyde resins, and polyketone resins;
and the like, including mixtures thereof.

In some embodiments, other than the terpene resin (A), and any optional rosin resin (D), the inkjet inks are substantially free of additional binder resins/tackifiers/adhesive substances, such as those mentioned above. In some embodiments, the inkjet inks are substantially free of polyurethane resins. In some embodiments, the terpene resin (A) is the only binder resin/tackifier/adhesive substance present in the inkjet inks. In some embodiments, the inkjet inks contain a combination of the terpene resin (A) and the rosin resin (D), and are preferably substantially free of additional resins, binders, tackifiers, or adhesive substances.

### (E) Colorant

It is to be readily appreciated by those of ordinary skill in the art that one or more colorants (E) may be optionally included in the inkjet inks to provide colored inks that may be used for a variety of printing purposes and the inkjet inks are not limited to any particular color. Any colorant (E) can be employed in the inkjet inks to provide the desired color, including dyes, pigments, mixtures thereof, and the like, provided that the colorant (E) can be dissolved or dispersed within the inkjet inks. Suitable colors include, for example, cyan, magenta, yellow, and key (black) (“CMYK”), white, orange, green, light cyan, light magenta, violet, and the like, including both spot colors and process colors. In general, the colorants (E) may be employed in amounts of at least 0.1 wt. %, preferably at least 0.5 wt. %, preferably at least 1 wt. %, preferably at least 2 wt. %, preferably at least 3 wt. %, and up to 20 wt. %, preferably up to 15 wt. %, preferably up to 10 wt. %, preferably up to 8 wt. %, preferably up to 7 wt. %, relative to a total weight of the inkjet inks.

The inkjet inks can be formulated with various dyes, with particular preference given to organic dyes such as OIL BLACK 860, available from Orient Chemical Industries, and metal complex dyes.

The inkjet inks can be formulated with various inorganic pigments and/or organic pigments. In addition to providing color to the inkjet inks, such pigments may be capable of improving the light resistance, the weather resistance, etc., of the printed images.

### (F) Additive(s)

In addition to the components already mentioned, the inkjet inks may also optionally be formulated with various additives (F) to improve various ink characteristics and performance. For example, the inkjet inks may optionally contain one or more of an anti-kogation agent, a stabilizer, a humectant, and a security taggant, in art appropriate levels as known by those of ordinary skill in the art.

### Methods of Making

Embodiments of the inkjet inks described herein may be prepared by any suitable technique known to those of ordinary skill in the art, for example by combining components (A) a terpene resin, (C) a polyether modified silicone, and any desired optional ingredients (e.g., (D) a rosin resin, (E) a colorant, and/or an additive (F)) with a suitable solvent system (B) comprising or consisting of (B1) methyl ethyl ketone and optionally one or more of (B2) acetone and (B3) glycol ether, in any order and stirring, agitating, and/or homogenizing at a temperature between 20 and 100° C. for a suitable amount of time to form a homogeneous solution.

In one example, the inkjet ink may be made by first combining the terpene resin (A) and the polyether modified silicone (C) with methyl ethyl ketone (B1), and any optional resins (e.g., (D) a rosin resin) or other optional additive(s) (F) in a vessel, followed by stirring for at least 10 minutes, preferably at least 15 minutes, preferably at least 20 minutes, preferably at least 25 minutes, preferably at least 30 minutes, preferably at least 35 minutes, preferably at least 40 minutes, preferably at least 45 minutes. Acetone (B2) and/or glycol ether (B3), when employed, may then be added to the resulting mixture, and subsequently stirred for at least 10 minutes, preferably at least 15 minutes, preferably at least 20 minutes, preferably at least 25 minutes. The colorant (E) may then be added as the final component with continued mixing, and the solution may then be mixed for at least 10 minutes, preferably at least 15 minutes, preferably at least 20 minutes, preferably at least 25 minutes, preferably at least 30 minutes, preferably at least 35 minutes, preferably at least 40 minutes, preferably at least 45 minutes to afford the inkjet ink. The resulting inkjet ink may then be placed into a printing cartridge, such as e.g., a FUNAI TIJ cartridge made by Funai Co., or other printhead suitable for MEK-based ink.

### Properties

Among other advantages, the inkjet inks disclosed herein possess a superior combination of extended decap times and quick dry times after being applied, and provide quality image sharpness even on non-porous substrates which tend to promote ink spreading. The inkjet inks disclosed herein can also be advantageously tuned to provide desired gloss.

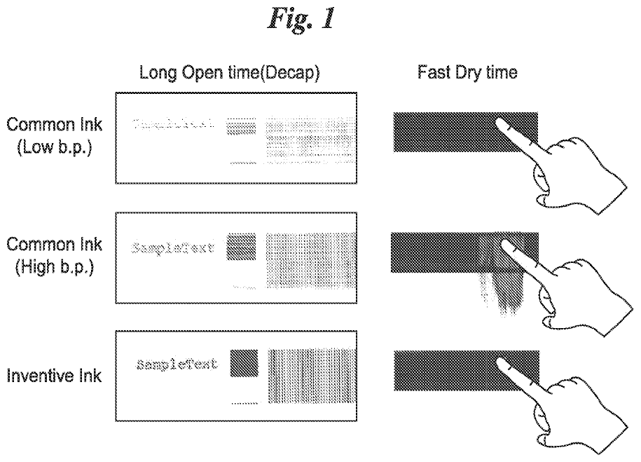

Dry times may be measured by applying the inkjet inks in the form of a solid block image (e.g., 1 cm*10 cm) onto a substrate, waiting for the inkjet inks to dry under ambient conditions (in air at room temperature, about 23° C., without applied heat), for a certain period of time, for example at 5, 10, 20, or 30 seconds, and then performing an abrasion test by finger to test if color transfers from the printed image to the finger at the tested time interval (see e.g., FIG. 1). If color transfer occurs, then the tested dry time is not satisfactory to achieve complete drying (rated “fail”). If no color transfer occurs, then the tested dry time is satisfactory to achieve complete drying (rated “pass”). Any inkjet inks requiring dry times of over 30 seconds to achieve a “pass” rating are considered unacceptable/slow drying (“Not Good”), those which achieve a “pass” rating with dry times of >20-30 seconds are deemed “acceptable”, those which achieve a “pass” rating with dry times of >10-20 seconds are deemed “fast”, and those which achieve a “pass” rating with dry times of 10 seconds or less are deemed “very fast”. In preferred embodiments, the inkjet inks of the present disclosure dry within 30 seconds or less, preferably 25 seconds or less, more preferably 20 seconds or less, even more preferably 15 seconds or less, yet even more preferably 10 seconds or less after being applied, and thus have an “acceptable”, “fast”, or “very fast” dry time rating, preferably a “fast” or “very fast” dry time rating, more preferably a “very fast” dry time rating.

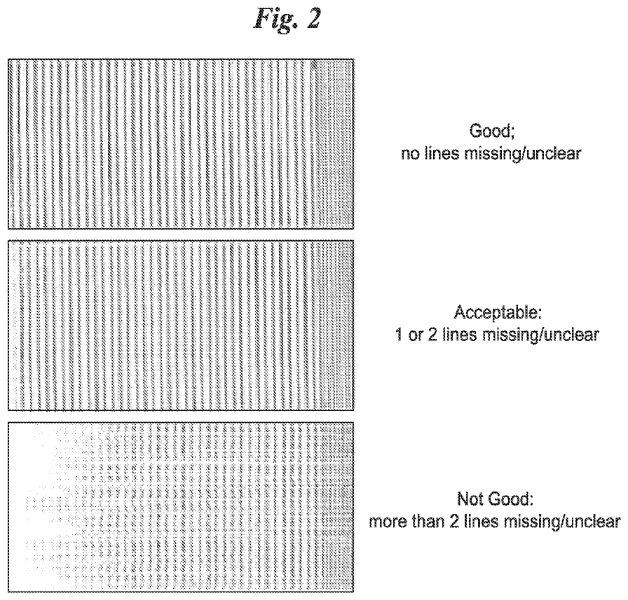

The inkjet inks disclosed herein also possess extended decap times, for example as measured by printing a narrow line picture (e.g., barcode) (1 mm*1 cm, narrow lines, Monochrome bitmap), exposing the inkjet ink to air (decapping the ink cartridge) for a particular time (e.g., 30 seconds, 1 minute, 60 minutes, etc.), reprinting the same narrow line image, and comparing the reprinted image after decapping to the original image to determine if loss of lines/loss of line clarity occurs in the narrow line image (see e.g., FIG. 2). If no loss of lines/loss of line clarity occurs at the tested time interval, then the inkjet inks are given a “Good” decap rating for that time interval. If 1-2 lines are lost/lost clarity at the tested time interval, but not enough to significantly affect the clarity or readability of the narrow line image, then the inkjet inks are given an “Acceptable” decap rating. If more than 2 lines are lost/lost clarity at the tested time interval, then the inkjet ink is classified as “Not Good” at that time interval. Suitable inkjet inks are those which can be decapped for time intervals of seconds, 1 minute, and 60 minutes, and achieve a “Good” or an “Acceptable” decap classification when decapped (i.e., exposed to air) for one or more of the tested time intervals, preferably two or more of the tested time intervals, more preferably at each tested time interval. Preferred inkjet inks are those which maintain a “Good” or “Acceptable” decap rating when decapped for 30 seconds or longer, preferably 1 minute or longer, more preferably 10 minutes or longer, even more preferably 30 minutes or longer, yet even more preferably 60 minutes or longer.

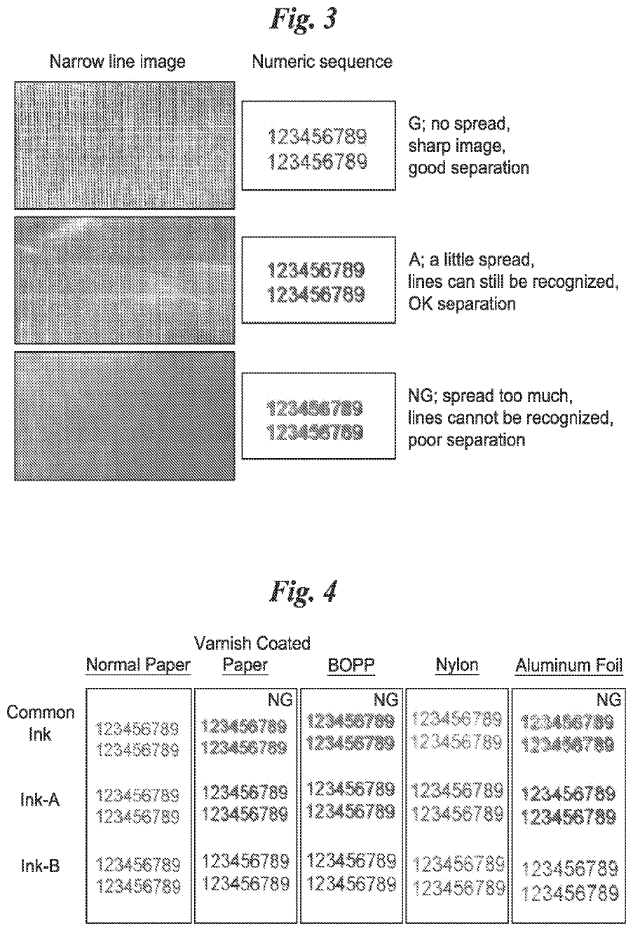

To test the inkjet inks for image sharpness, a narrow line image and a numeric sequence may be printed onto a porous control substrate (normal non-coated paper), and a series of non-porous substrates (e.g., varnish coated paper, biaxially oriented polypropylene, nylon, and aluminum foil). The printed images may then be visually evaluated on each substrate for spreading. Inkjet inks which provide a narrow line image with no spreading/all individual lines can be recognized, and a numeric sequence in which each digit is clear and separated from adjacent digits, are given a “G” (good) evaluation. Inkjet inks which provide a narrow line image where some spreading occurs but individual lines can still be recognized and a numeric sequence in which each digit is clear but some digits are not separated from adjacent digits are given a “A” (acceptable) evaluation. Inkjet inks which provide a narrow line image where substantial spreading occurs to the point where individual lines cannot be recognized and a numeric sequence in which the digits are not clear (spread too much) and are generally not separated from adjacent digits are given a “NG” (not good) evaluation (see e.g., FIGS. 3 and 4). The evaluations on each substrate are then compiled and the inkjet inks are rated for image sharpness according to the following criteria: a “Good” rating when only “G” evaluations are obtained, an “Acceptable” rating when both “G” and “A” evaluations are obtained without any “NG” evaluations, and a “Not Good” rating when an “NG” evaluation is obtained on at least one substrate.

Another advantage of the disclosed inkjet inks is that they can be readily tuned in terms of gloss to provide printed images which have high, medium, or low gloss, as desired for a particular application. The gloss may be evaluated by simple visual inspection methods and categorized as “High” gloss, “Medium” gloss, or “Low” gloss. Alternatively, a glossmeter (e.g., BYK-Gardner haze-gloss reflectometer, from BYK-Gardner Geretsiried, Germany) may be used to measure the gloss intensity of a printed image at a 60° measurement angle (specular reflection) and the gloss may be recorded in terms of gloss units (GU), with “High” gloss being a 60° value of >70 GU, “Medium” gloss being a 60° value of to 70 GU, and “Low” gloss being a 60° value of <10 GU.

### Printed Article

The inkjet inks can be printed on various substrates including three dimensional parts as well as flat sheets or webs that are supplied in roll form, for the manufacture of a wide variety of printed articles. Additionally, the substrates may possess various surface types, for example, a flat surface, a structured surface, such as grained surfaces, and a three-dimensional surface, such as curved and/or complex surfaces, which are notoriously difficult substrates owing to the long distance that the ink must travel to reach all parts of the curved and/or complex surface. Such printed articles may be suitable in the graphic arts, textiles, packaging (e.g., food packaging, pharmaceutical packaging, etc.), lottery, direct mail, business forms and publishing industries, examples of which include a tag or label, a lottery ticket, a publication, packaging (e.g., food packaging, pharmaceutical packaging, blister packaging, other various flexible packing, etc.), a folding carton, a rigid container (e.g., a plastic cup or tub, glass containers, metal cans, bottles such as PET bottles, jars, and tubes), envelopes, corrugate, a point-of-sale display, and the like.

The inkjet inks may be printed on porous (or penetrable) substrates, examples of which include, but are not limited to, non-coated paper, wood, membranes, corrugate (corrugated cardboard/fiberboard), and fabrics (including, for example, but not limited to, woven fabric, non-woven fabric, and foil-laminated fabric).

The inkjet inks may also be printed on non-porous (or non-penetrable substrates), for example, various plastics, glass, metals (e.g., steel, aluminum, etc.), and/or non-penetration papers (e.g., coated papers such as varnish coated papers), including, but not limited to, molded plastic or metal parts as well a flat sheets or rolls of plastic or metallic films. Examples include those substrates containing polyesters such as polyethylene terephthalate (PET), biaxially oriented polystyrene (OPS), polyolefins such as polyethylene (PE), polypropylene (PP), oriented polypropylene (OPP), and biaxially oriented polypropylene (BOPP), polylactic acid (PLA), nylon and oriented nylon, polyvinyl chloride (PVC), cellulose triacetate (TAC), polycarbonate, acrylonitrile butadiene styrene (ABS), polyacetal, polyvinyl alcohol (PVA), coated papers such as varnish coated papers, and metals such as steel and aluminum, and the like. In particular, the inkjet inks of the present disclosure have been formulated for use on such non-porous substrates without excessive spreading, enabling the formation of sharp images even on the most challenging substrates such as aluminum foil.

### Method of Forming a Printed Image

With inkjet printing, a desired printed image is formed when a precise pattern of dots is ejected from a drop-generating device, known as a printhead, onto a print medium. The printhead has an array of precisely formed nozzles located on a nozzle plate and attached to an inkjet printhead substrate. The inkjet printhead substrate incorporates an array of firing chambers that receive inkjet ink through fluid communication with one or more ink reservoirs. Each firing chamber has a resistor element, known as a firing resistor, located opposite the nozzle so that the inkjet ink collects between the firing resistor and the nozzle. Each resistor element is typically a pad of a resistive material and measures for example about 35 μm×35 μm. The printhead is held and protected by an outer packaging referred to as a print cartridge or an inkjet pen. Upon energizing of a particular resistor element, a droplet of inkjet ink is expelled through the nozzle toward the print medium. The firing of ink droplets is typically under the control of a microprocessor, the signals of which are conveyed by electrical traces to the resistor elements, forming alphanumeric and other image patterns on the print medium. Since the nozzles are small, typically 10 μm to 40 μm in diameter, inks that minimize clogging are desired. In particular, since thermal inkjet (TIJ) is an open atmosphere print head design (the nozzle orifices are open to atmosphere and there is no valve seal at the orifice to allow ink pressurization), TIJ printing has historically suffered from poor performance during intermittent printing, where decap time (print idle time) causes premature drying of ink in and around the nozzles.

The present disclosure provides a method of forming a printed image by applying the inkjet ink, in one or more of its embodiments, onto a surface of a substrate by a thermal inkjet printhead and allowing the inkjet ink to dry. Use of the inkjet inks described herein overcomes the competing problems of short decap time (rate of solvent loss is too fast) and slow drying times (rate of solvent loss is too slow) commonly associated with thermal inkjet processes, while still producing high quality prints, even on ‘difficult’ non-porous substrates.

Any drop on demand printhead known to those of ordinary skill in the art of inkjet printing can be used as printing units in the present method, including continuous printheads, thermal printheads, electrostatic printheads, and acoustic printheads, preferably a thermal printhead (having a thermal transducer) is used. Typical parameters, such as, for example, printing resolution, printing speed, printhead pulse warming temperature, driving voltage and pulse length, can be adjusted according to the specifications of the printhead. Printheads which are generally suitable for usage in the methods herein have a droplet size in the range of 2 to 80 pL and a droplet frequency in the range of 10 to 100 kHz, and high quality prints may be obtained for example by setting the driving voltage to 8.0 to 9.5 Volts, the print speed up to 300 feet/minute, the pulse warming temperature to 25 to 45° C., and the pulse length to 0.7-2.5 microseconds, although values above or below these described may also be used and still obtain satisfactory prints. One non-limiting printhead example suitable for use in the disclosed methods is FUNAI TIJ cartridge made by Funai Co.

After application, the inkjet ink is dried. In preferred embodiments, drying is achieved by allowing the applied inkjet ink to dry under ambient conditions (in air, at about 23° C.) for seconds or less, preferably 25 seconds or less, more preferably 20 seconds or less, even more preferably 15 seconds or less, yet even more preferably 10 seconds or less.

While external heat may be applied to dry the applied inkjet inks, in preferred embodiments, external heat is not applied to facilitate drying or to increase drying speeds. For example, a heater is preferably not employed for drying the inkjet ink after application. Furthermore, the methods of the present disclosure do not require energy curing (e.g., UV or electron beam curing). Once the applied ink is deemed dry, further coatings of inkjet ink may be applied, or any processing steps known to those of ordinary skill in the art may be performed as desired.

It should also be recognized that substrate surface treatments such as corona treatment, atmospheric plasma treatment, and flame treatment may optionally be employed in the methods herein prior to application of the inkjet inks to improve printed article characteristics, for example ink adhesion. The parameters of such substrate surface treatments may be varied greatly depending on the substrate material to be printed, the specific inkjet ink utilized, the printing method applied, and the desired properties and applications of the printed article.

The examples below are intended to further illustrate the inkjet inks and are not intended to limit the scope of the claims.

### EXAMPLES

### Inkjet Inks

Several example inkjet inks are given in Tables 1 and 2 below. The amount of each component is expressed in terms of weight percentage relative to a total weight (100%) of the inkjet ink. * denotes the example is a comparative example.

### Materials Used

Glycol ether PnP is propylene glycol mono-n-propyl ether (b.p. 150° C.). Glycol ether DPnP is dipropylene glycol mono-n-propyl ether (b.p. 212° C.). PICCOLYTE A135 is a terpene resin made from α-pinene (ring-and-ball SP=132-138° C., bromine number=27), available from Pinova. PICCOLYTE S25 is a terpene resin made from p-pinene (ring-and-ball SP=22-28° C., bromine number 19), available from Pinova. DERTOPHENE T is a terpene phenol resin (OHV=40 mgKOH/g), available from Pinova. FORAL AX is a rosin resin (a hydrogenated acidic wood rosin), available from Pinova. KF-6011 (PEG-11 dimethicone, methyl ether capped, HLB=14.5), KF-6013 (PEG-9 dimethicone, uncapped, HLB=10.0), KF-6015 (PEG-3 dimethicone, uncapped, HLB=4.5), KF-6017 (PEG-10 dimethicone, uncapped, HLB=4.5), and KF-6038 (Lauryl PEG-9 polydimethylsiloxyethyl dimethicone, uncapped. HLB=3.0) are polyether modified silicones, each available from Shin-Etsu Chemical Co. BYK-3550 is a silicone acrylate copolymer, available from BYK Japan K.K. OIL BLACK 860 is an organic dye, available from Orient Chemical Industries.

TABLE 1
Inkjet Ink Examples 1-12

| | Ex 1* | Ex 2* | Ex 3 | Ex 4 | Ex 5 | Ex 6 | Ex 7 |
|---|---|---|---|---|---|---|---|
| MEK | 67.000 | 66.950 | 66.950 | 66.950 | 66.999 | 66.990 | 66.950 |
| Acetone | 20.000 | 20.000 | 20.000 | 20.000 | 20.000 | 20.000 | 20.000 |
| PICCOLYTE | 2.000 | 2.000 | 2.000 | 2.000 | 2.000 | 2.000 | 2.000 |
| A135 | | | | | | | |
| FORAL AX | 1.000 | 1.000 | 1.000 | 1.000 | 1.000 | 1.000 | 1.000 |
| KF-6011 | — | 0.050 | — | — | — | — | — |
| (HLB = 14.5) | | | | | | | |
| KF-6013 | — | — | 0.050 | — | — | — | — |
| (HLB = 10.0) | | | | | | | |
| KF-6015 | — | — | — | 0.050 | — | — | — |
| (HLB = 4.5) | | | | | | | |
| KF-6017 | — | — | — | — | 0.001 | 0.010 | 0.050 |
| (HLB = 4.5) | | | | | | | |
| KF-6038 | — | — | — | — | — | — | — |
| (HLB = 3.0) | | | | | | | |
| BYK-3550 | — | — | — | — | — | — | — |
| OIL BLACK | 10.000 | 10.000 | 10.000 | 10.000 | 10.000 | 10.000 | 10.000 |
| 860 | | | | | | | |
| Total | 100.000 | 100.000 | 100.000 | 100.000 | 100.000 | 100.000 | 100.000 |

| | Ex 8 | Ex 9 | Ex 10 | Ex 11 | Ex 12* |
|---|---|---|---|---|---|
| MEK | 66.900 | 66.000 | 64.000 | 66.950 | 66.950 |
| Acetone | 20.000 | 20.000 | 20.000 | 20.000 | 20.000 |
| PICCOLYTE | 2.000 | 2.000 | 2.000 | 2.000 | 2.000 |
| A135 | | | | | |
| FORAL AX | 1.000 | 1.000 | 1.000 | 1.000 | 1.000 |
| KF-6011 | — | — | — | — | — |
| (HLB = 14.5) | | | | | |
| KF-6013 | — | — | — | — | — |
| (HLB = 10.0) | | | | | |
| KF-6015 | — | — | — | — | — |
| (HLB = 4.5) | | | | | |
| KF-6017 | 0.100 | 1.000 | 3.000 | — | — |
| (HLB = 4.5) | | | | | |
| KF-6038 | — | — | — | 0.050 | — |
| (HLB = 3.0) | | | | | |
| BYK-3550 | — | — | — | — | 0.050 |
| OIL BLACK | 10.000 | 10.000 | 10.000 | 10.000 | 10.000 |
| 860 | | | | | |
| Total | 100.000 | 100.000 | 100.000 | 100.000 | 100.000 |

*denotes the example is a comparative example

TABLE 2
Inkjet Ink Examples 13-19

| | Ex 13* | Ex 14* | Ex 15 | Ex 16* | Ex 17 | Ex 18 | Ex 19 |
|---|---|---|---|---|---|---|---|
| MEK | 66.950 | 66.950 | 66.950 | — | 66.950 | 66.950 | 86.95 |
| Acetone | 20.000 | 20.000 | 20.000 | 20.000 | — | — | — |
| Ethanol | — | — | — | 66.950 | — | — | — |
| Glycol ether PnP | — | — | — | — | 20.000 | — | — |
| (b.p. 150° C.) | | | | | | | |
| Glycol ether DPnP | — | — | — | — | — | 20.000 | — |
| (b.p. 212° C.) | | | | | | | |
| PICCOLYTE A135 | — | — | 3.000 | — | 2.000 | 2.000 | — |
| PICCOLYTE S25 | — | — | — | — | — | — | 2.000 |
| DERTOPHENE T | 2.000 | — | — | 3.000 | — | — | — |
| FORAL AX | 1.000 | 3.000 | — | — | 1.000 | 1.000 | 1.000 |
| KF-6017 | 0.050 | 0.050 | 0.050 | 0.050 | 0.050 | 0.050 | 0.050 |
| (HLB = 4.5) | | | | | | | |
| OIL BLACK 860 | 10.000 | 10.000 | 10.000 | 10.000 | 10.000 | 10.000 | 10.000 |
| Total | 100.000 | 100.000 | 100.000 | 100.000 | 100.000 | 100.000 | 100.000 |

*denotes the example is a comparative example

### Preparation Methods

To prepare the example inks, the resin(s) and any surfactant were first combined with methyl ethyl ketone (MEK), and mixed by mechanical stirrer for at least 30 minutes. Then acetone or glycol ether was added into the mixture and mixed for at least 15 minutes. The dye was then added into the mixture and mixed for at least 30 minutes to obtain the inkjet inks. The inkjet ink examples were then evaluated through a FUNAI TIJ cartridge made by Funai Co.

### Softening Point (SP) Values of Resins

One example method for determining the softening point of resins is as follows: A 2.1 g sample in a molten state is injected into a given ring, and the sample is then cooled to room temperature, and thereafter the SP values are measured under the following conditions as prescribed in JIS B7410.
Measuring apparatus: Automatic Ring-and-Ball Softening Point;
Tester ASP-MGK2 (manufactured by MEITECH Company Ltd.);
Heating rate: 5° C./min;
Temperature at which heating is started: 40° C.;
Measurement solvent: glycerol.

### Inkjet Ink Evaluation Methods

### Printing Sample Preparation

Thermal printing technology related to FUNAI was used to evaluate the inks (Software and hardware made by XiJet, Transport table made by Kirk Rudy).

### Dry Time Evaluation

For evaluating dry times, the printing conditions utilized were as follows:
Printing substrate; varnish coated paper
Printing resolution; 600 dpi*300 dpi (vertical*horizontal)
Printing speed; 100 feet/minute
Pre Fire 260 nsec
Dead Time 1200 nsec
Main Fire 500 nsec
Voltage 9.0 V
Temperature 30° C.
Printing image; 100% duty (1 cm*10 cm, Monochrome bitmap, solid block image) (see e.g., FIG. 1)

The abrasion test was done by the finger after specific time passed (10, 20, and 30 sec). A colored finger indicates not enough time has lapsed for complete drying (“fail”), and a non-colored finger indicates the time is adequate for complete drying (“pass”). Inkjet inks were then rated according to the dry times needed to achieve a “pass” rating according to Table 3 below.

TABLE 3
Dry time rating

| | |
|---|---|
| Very Fast | ≤10 second dry time to achieve a “pass” rating |
| Fast | >10-20 second dry time to achieve “pass” rating |
| Acceptable | >20-30 second dry time to achieve “pass” rating |
| Not Good | >30 second dry time to achieve “pass” rating |

### Decap Time Evaluation

For evaluating decap times, the printing conditions utilized were as follows:
Printing substrate; normal (non-coated) paper
Printing resolution; 300 dpi*300 dpi (vertical*horizontal)
Printing speed; 100 feet/minute
Pre Fire 260 nsec
Dead Time 1200 nsec
Main Fire 500 nsec
Voltage 9.0 V
Temperature 30° C.
Printing image; 100% duty (1 mm*1 cm. Monochrome bitmap, narrow line image)(see e.g., FIG. 2)

The narrow line image was printed to confirm that there were no missing or unclear lines included in the printed image (signifying plugged or missing nozzles). After confirming, the printhead was left decapped for a specific time (30 seconds, 1 min, or 60 min), then reprinted using the same narrow line image. The reprinted narrow line image (after the specific time lapse) was checked to determine whether loss of lines/loss of line clarity occurred. If no loss of lines/loss of line clarity occurred at the tested time interval, then the inkjet inks were given a “Good” decap rating for that time interval. If 1-2 lines were lost/lost clarity at the tested time interval, but not enough to significantly affect the clarity or readability of the narrow line image, then the inkjet inks were given an “Acceptable” decap rating at the tested time interval. If more than 2 lines were lost/lost clarity at the tested time interval, then the inkjet inks were classified as “Not Good” at that time interval. Suitable/desirable inkjet inks are those which achieve a “Good” or an “Acceptable” decap classification when decapped (i.e., exposed to air) for one or more of the tested time intervals.

### Image Sharpness Evaluation

For evaluating the image sharpness, the printing conditions utilized were as follows:
Printing substrates used for determining image sharpness were normal (non-coated) paper, varnish coated paper, biaxially oriented polypropylene, nylon, and aluminum foil
Printing resolution; 300 dpi*300 dpi (vertical*horizontal)
Printing speed; 100 feet/minute
Pre Fire 260 nsec
Dead Time 1200 nsec
Main Fire 500 nsec
Voltage 9.0 V
Temperature 30° C.
Printing image; 100% duty (see e.g., FIGS. 3 and 4)
   1 mm*12.7 mm, Monochrome bitmap, narrow line image,
   Numeric sequence which reads “123456789”

The narrow line image and numeric sequence were printed onto a porous control substrate (normal non-coated paper), and a series of non-porous substrates: varnish coated paper, biaxially oriented polypropylene, nylon, and aluminum foil. The resulting printed images were visually evaluated on each substrate for spreading, according to the evaluation criteria in Table 4 below.

TABLE 4
Individual substrate sharpness evaluation

| Evaluation | Narrow line image | Numeric sequence |
|---|---|---|
| G | No spread; all | Each digit was clear |
| | lines recognized | and separated from |
| | | adjacent digits |
| A | Some spreading | Each digit was clear; |
| | occurred; lines | some digits were not |
| | can still be recognized | separated from adjacent digits |
| NG | Substantial | Digits were not clear (spread too |
| | spreading occurred; | much); digits were generally not |
| | lines cannot be recognized | separated from adjacent digits |

The results from the above evaluation on each substrate were then compiled and the inkjet inks were then given an image sharpness rating of “Good”, “Acceptable”, or “Not Good” according to the rating system in Table 5 below.

TABLE 5
Inkjet ink image sharpness rating

| | |
|---|---|
| Good | Inkjet inks with a “G” evaluation on every substrate |
| Acceptable | Inkjet inks with “G” and “A” evaluations, |
| | and no “NG” evaluations |
| Not Good | Inkjet inks receiving a “NG” evaluation for |
| | at least one substrate |

### Gloss Evaluation

After complete drying, the printed image samples from the Dry time measurements were visually inspected for gloss and categorized as “High” gloss, “Medium” gloss, or “Low” gloss.

### Inkjet Ink Performance

As shown in Tables 6 and 7 below, inkjet inks formulated with a polyether modified silicone having an HLB value of 1 to 12 and methyl ethyl ketone were found to have “Acceptable” or “Good” image sharpness ratings (Examples 3-11, 13-15, 17-19). Conversely, inkjet inks which contained no surfactant (Example 1), a polyether modified silicone with too high an HLB value (Example 2, using a polyether modified silicone surfactant with an HLB value of 14.5), a silicone acrylate copolymer (Example 12, using BYK-3550 as surfactant), or where MEK was replaced with another low boiling solvent (Example 16, using ethanol), were each found to provide unacceptable images in terms of image sharpness (see Tables 6 and 7).

TABLE 6
Inkjet Ink Performance of Examples 1-12

| | Ex 1* | Ex 2* | Ex 3 | Ex 4 | Ex 5 | Ex 6 | Ex 7 | Ex 8 | Ex 9 | Ex 10 | Ex 11 | Ex 12* |
|---|---|---|---|---|---|---|---|---|---|---|---|---|
| Dry time | Very | Very | Very | Very | Very | Very | Very | Very | Very | Very | Very | Very |
| | Fast | Fast | Fast | Fast | Fast | Fast | Fast | Fast | Fast | Fast | Fast | Fast |
| Decap | Good | Good | Good | Good | Good | Good | Good | Acceptable | Acceptable | Not | Good | Good |
| Time/ | | | | | | | | | | Good | | |
| 30 sec | | | | | | | | | | | | |
| Decap | Good | Good | Good | Good | Good | Good | Good | Good | Acceptable | Not | Good | Good |
| Time/ | | | | | | | | | | Good | | |
| 1 min | | | | | | | | | | | | |
| Decap | Good | Good | Good | Good | Good | Good | Good | Good | Good | Good | Good | Good |
| Time/ | | | | | | | | | | | | |
| 60 min | | | | | | | | | | | | |
| Sharpness | Not | Not | Acceptable | Good | Acceptable | Good | Good | Good | Good | Good | Acceptable | Not |
| | Good | Good | | | | | | | | | | Good |
| Gloss | High | High | High | High | High | High | High | High | High | High | High | High |

*denotes the example is a comparative example

TABLE 7
Inkjet Ink Performance of Examples 13-19

| | Ex 13* | Ex 14* | Ex 15 | Ex 16* | Ex 17 | Ex 18 | Ex 19 |
|---|---|---|---|---|---|---|---|
| Dry time | Very Fast | Very Fast | Very Fast | Fast | Fast | Acceptable | Very Fast |
| Decap Time/ | Not Good | Not Good | Good | Acceptable | Good | Good | Good |
| 30 sec | | | | | | | |
| Decap Time/ | Not Good | Not Good | Good | Acceptable | Good | Good | Acceptable |
| 1 min | | | | | | | |
| Decap Time/ | Not Good | Not Good | Good | Good | Good | Good | Acceptable |
| 60 min | | | | | | | |
| Sharpness | Good | Good | Good | Not Good | Good | Good | Good |
| Gloss | Medium | High | Medium | Medium | High | High | High |

*denotes the example is a comparative example

In terms of the quantity of polyether modified silicone having an HLB value of 1 to 12, even extremely low loadings were found to be sufficient for producing acceptable image sharpness (Example 5, with a 0.001 wt. % loading of polyether modified silicone). Higher loadings of polyether modified silicone, such as 1 wt. % in Example 9 and 3 wt. % in Example 10, also provided desirable image sharpness, although a 3 wt. % loading of the polyether modified silicone began to effect early decap times (Table 6, Example 10). Even still, Example 10 at a 3 wt. % loading of the polyether modified silicone performed well at the longest decap time tested of 60 minutes.

As can be seen in Tables 6 and 7, when a polyether modified silicone having an HLB value of 1 to 12 was used in combination with a terpene resin and methyl ethyl ketone, remarkable effects were achieved in terms of image sharpness, dry times, and decap times (Examples 3-11, 15, and 17-19).

On the other hand, inkjet inks in which the terpene resin was replaced with a terpene phenol resin (Example 13), or in which only a rosin resin was used (Example 14) suffered from unacceptable decap times at all decap times tested (Table 7).

In addition to solvent systems based on mixtures of MEK and acetone (Examples 3-11, and 15). MEK can be used alone (Example 19), or MEK can be used in combination with glycol ether (Examples 17 and 18) to produce inkjet inks with desirable decap times, albeit inks prepared using a combination of MEK and glycol ether provided slightly longer dry times.

Where a numerical limit or range is stated herein, the endpoints are included. Also, all values and subranges within a numerical limit or range are specifically included as if explicitly written out.

As used herein the words “a” and “an” and the like carry the meaning of “one or more.”

The present disclosure also contemplates other embodiments “comprising”, “consisting of” and “consisting essentially of”, the embodiments or elements presented herein, whether explicitly set forth or not.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. An inkjet ink, comprising:
(A) a terpene resin;
(B) a solvent system comprising (B1) methyl ethyl ketone; and
(C) a polyether modified silicone having a hydrophilic-lipophilic balance (HLB) value of 1 to 12.

2. The inkjet ink of claim 1, wherein the terpene resin (A) is a homopolymer made from α-pinene.

3. The inkjet ink of claim 1, wherein the terpene resin (A) is present in an amount of 0.1 to 10 wt. %, based on a total weight of the inkjet ink.

4. The inkjet ink of claim 1, wherein a weight ratio of the methyl ethyl ketone (B1) to the terpene resin (A) ((B1):(A)) is 10:1 to 100:1.

5. The inkjet ink of claim 1, wherein the solvent system (B) further comprises (B2) acetone.

6. The inkjet ink of claim 5, wherein a weight ratio of the methyl ethyl ketone (B1) to acetone (B2) ((B1):(B2)) is 1:1 to 5:1.

7. The inkjet ink of claim 1, which has a total ketone content of at least 50 wt. %, based on a total weight of the inkjet ink.

8. The inkjet ink of claim 1, wherein the solvent system (B) further comprises (B3) a glycol ether.

9. The inkjet ink of claim 1, which is substantially free of solvents having a boiling point higher than 175° C.

10. The inkjet ink of claim 1, wherein the polyether modified silicone (C) is a block copolymer having a pendent graft structure.

11. The inkjet ink of claim 1, wherein the polyether modified silicone (C) has an HLB value of 3 to 10.

12. The inkjet ink of claim 1, wherein the polyether modified silicone (C) is present in an amount of 0.001 to 4 wt. %, based on a total weight of the inkjet ink.

13. The inkjet ink of claim 1, further comprising (D) a rosin resin.

14. The inkjet ink of claim 13, wherein the rosin resin (D) is a hydrogenated acidic rosin.

15. The inkjet ink of claim 13, wherein the rosin resin (D) is present in an amount of up to 10 wt. %, based on a total weight of the inkjet ink.

16. The inkjet ink of claim 1, further comprising (E) a colorant.

17. A printed article, comprising:
a substrate and a dried form of the inkjet ink of claim 1 disposed on the substrate.

18. A method of forming a printed image on a substrate, comprising:
applying the inkjet ink of claim 1 onto the substrate with a thermal inkjet printhead; and
drying the inkjet ink.

19. The method of claim 18, wherein the inkjet ink is dried by leaving exposed to air for 30 seconds or less.

20. The method of claim 18, wherein a heater is not employed for drying the inkjet ink.
